(19) United States
(12) Patent Application Publication
(10) Pub. No.: US 2010/0259684 A1
(43) Pub. Date: Oct. 14, 2010

(54) CONTENT DISPLAY PROCESSING DEVICE AND CONTENT DISPLAY PROCESSING METHOD

(75) Inventor: Nobuhiro Kambe, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/740,521

(22) PCT Filed: Sep. 2, 2009
(86) PCT No.: PCT/JP2009/004317

§ 371 Date: Apr. 29, 2010

(30) Foreign Application Priority Data
Sep. 2, 2008 (JP) P2008-224590

(51) Int. Cl. H04N 9/76

(52) U.S. Cl. 348/598; 348/E05.056

(57) ABSTRACT

There is performed processing for displaying content on a video image so that the content is superimposed on the video image without blocking an important portion of the video image. A content display processing device includes a video image acquisition section that acquires a video image made up of a plurality of still images; a content acquisition section that acquires content to be displayed on the video image in a superimposed manner; an image processing section that extracts the still image from the video image; an image recognition section that detects, from the still image extracted by the image processing section, an area which includes at least a portion of an outer edge of the still image and a portion except a main display object in the still image; a content layout section that determines content display information indicating a layout and a size of the content according to the area detected by the image recognition section; and a display processing section that performs processing so as to display the content while the content is superimposed on the video image, in accordance with the content display information determined by the content layout section.

### TECHNICAL FIELD

The present invention relates to content display processing device and content display processing method that displays a video image while content is superimposed on the video image.

### BACKGROUND ART

A device that displays video images, such as a TV set, can simultaneously display content showing a status of the device, a data broadcast, content acquired by way of the Internet, and the like, on a video image acquired from a broadcast or by way of an external input terminal. For instance, in order to superimpose content on a TV screen that displays a data broadcast, a video image can be displayed in a scaled-down manner. In this case, high priority is provided to displaying content on a TV screen, and a video image is excessively scaled down. This may make it difficult for the user to watch a video image displayed on a TV screen.

Therefore, content, such as information about a receiving channel and a setting screen for enabling performance of color control of a display screen, is made transparent, and the content is displayed, in a superimposed manner, on a video image appearing on a TV screen. However, since a position in the TV screen used for displaying content is fixed, content frequently overlay important portions of a video image.

For this reason, when content is displayed on a video image in a superimposed manner, an area involving the least amounts of changes in background color is selected from a plurality of preset areas that enable displaying of content according to the method described in connection with Patent Document 1. A color of character strings, or the like, making up content is changed in accordance with a color distribution of the selected area, and content is displayed on a video image while superimposed on the video image.

Related-Art Document

Patent Documents

Patent Document 1: JP-A-10-247135

Patent Document 2: JP-A-2001-357407

Patent Document 3: JP-A-5-165594

### DISCLOSURE OF THE INVENTION

### Problem that the Invention is to Solve

However, under the content display processing method described in connection with Patent Document 1, a plurality of candidates for locations used for positioning content must previously be set when content is displayed on a video image in a superimposed manner. Therefore, even when the content display processing method described in connection with Patent Document 1 is applied to a general broadcast, or the like, involving frequent occurrence of changes in a video image with time, it is difficult to prevent a preset position used for arranging content from overlaying an important portion of a video image.

An object of the present invention is to provide content display processing device and content display processing method that make it possible to display content on a video image in a superimposed manner without blocking an important portion of a video image.

### Means for Solving the Problem

The present invention provides a content display processing device comprising: a video image acquisition section that acquires a video image made up of a plurality of still images; a content acquisition section that acquires content to be displayed on the video image so that the content is superimposed on the video image; an image processing section that extracts the still image from the video image; an image recognition section that detects, from the still image extracted by the image processing section, an area which includes at least a portion of an outer edge of the still image and a portion except a main display object in the still image; a content layout section that determines content display information indicating a layout and a size of the content according to the area detected by the image recognition section; and a display processing section that performs processing so as to display the content while the content is superimposed on the video image, in accordance with the content display information determined by the content layout section.

The present invention also provides a content display processing method comprising: acquiring a video image made up of a plurality of still images; acquiring a content to be displayed on the video image so that the content is superimposed on the video image; extracting the still image from the video image; detecting, from the extracted still image, an area which includes at least a portion of an outer edge of the still image and a portion except from which a main display object in the still image; determining content display information indicating a layout and a size of the content according to the detected area; and displaying the content on the video image while the content is superimposed on the video image, in accordance with the determined content display information.

### ADVANTAGE OF THE INVENTION

The content display processing device and the content display processing method of the present invention make it possible to perform processing for displaying content while the content is superimposed on a video image without blocking an important portion of the video image.

### BRIEF DESCRIPTION OF THE DRAWINGS

FIG. 1 It is a view showing the configuration of a content display system having a content display processing device of Embodiment 1 of the present invention.

FIG. 2 It is a flowchart showing processing operation of the content display processing device of Embodiment 1 of the present invention.

FIG. 3 They are views for describing a content layout method for the content display processing device of Embodiment 1 of the present invention, wherein FIG. 3(a) is a view showing an example edge in an extracted image and example content to be displayed in a superimposed manner, FIG. 3(b) is a view showing three candidate areas that enable positioning of the content shown in FIG. 3(a), FIG. 3(c) shows a content display area in an area selected from the three candidate areas shown in FIG. 3(b), and FIG. 3(d) shows content displayed in the content display area shown in FIG. 3(c).

FIG. 4 They are views for describing a method for changing a content size in the content display processing device of Embodiment 1 of the present invention, wherein FIG. 4(a) is a view showing a still image 301 achieved before re-calculation, FIG. 4(b) is a view showing the still image 301 whose edge overlays content, FIG. 4(c) is a view showing the still image 301 in which content is stepwise scaled-down, and FIG. 4(d) is a view showing that a content image is superimposed on the still image 301 after re-calculation.

FIG. 5 They are views showing a change in content layout of the content display processing device of Embodiment 1 of the present invention, wherein FIG. 5(a) is a view showing an example display (1); FIG. 5(b) is a view showing an example display (2), FIG. 5(c) is a view showing an example display (3), and FIG. 5(d) is a view showing an example display (4).

FIG. 6 They are views showing types of content display methods for the content display processing device of Embodiment 1 of the present invention, wherein FIG. 6(a) is a view showing an example display (5); FIG. 6(b) is a view showing an example display (6), FIG. 6(c) is a view showing an example display (7), and FIG. 6(d) is a view showing an example display (8).

FIG. 7 It is a view for describing a method for re-calculating content display information in the content display processing device of Embodiment 1 of the present invention.

### BEST MODES FOR IMPLEMENTING THE INVENTION

Embodiments of the present invention are hereunder described by reference to the drawings.

### Embodiment 1

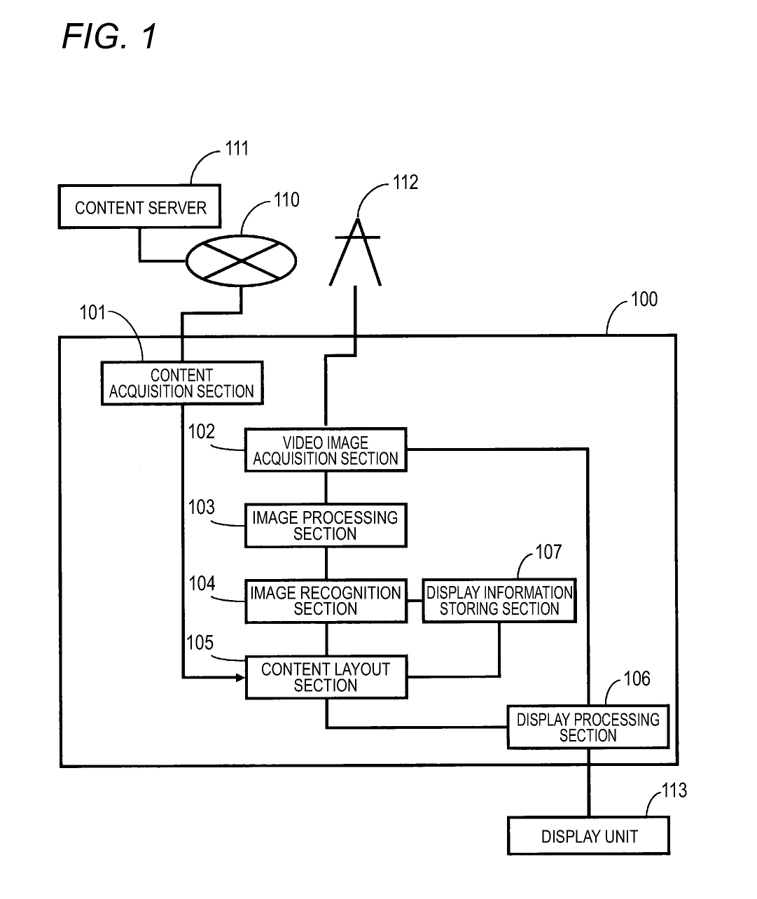

FIG. 1 is a view showing the configuration of a content display system having a content display processing device of Embodiment 1 of the present invention.

The content display system shown in FIG. 1 is made up of a content display processing device 100 that is a digital TV receiver; a network 110 made up of the Internet or a private line; a content server 111 that provides content; a broadcast station 112 that broadcasts a program made up of a video image and audio; and a display unit 113.

The term “video image” referred to herein implies both cases where a still image changes on a per-frame basis and where still images change in groups of several frames.

The network 110 is made up of a mobile communication network, a public phone network, a LAN, the Internet, and the like. The type of the network and the type of a protocol are not limited. A large-capacity line, such as an FTTH (Fiber to The Home), an HFC (Hybrid Fiber Coax: an optical coaxial cable), and an ADSL (Asymmetric Digital Subscriber Line), can be utilized as an access line of the network 110.

The content server 111 provides the content display processing device 100 with; for instance, content including information about a program being broadcast by the broadcast station 112, by way of the network 110. The content server 111 is built from a control section that is made up of a computer for controlling the entirety of the content display processing device, a communication interface that is connected to the network 110 and that transmits and receives accessed data, or the like, to; for instance, a URL on the Internet, and a database storing transmitted/received data.

The broadcast station 112 broadcasts a program. The content display processing device 100 receives the program broadcast by the broadcast station 112.

The display unit 113 displays a program received by the content display processing device 100.

The content display processing device 100 has a content acquisition section 101, a video image acquisition section 102, an image processing section 103, an image recognition section 104, a content layout section 105, a display processing section 106, and a display information storing section 107. Although unillustrated, an input device for accepting input operation performed by a user, an external recorder, and an interface for interconnecting various devices, are provided in the content display processing device 100. Moreover, although unillustrated, the content display processing device 100 can execute an application for making various settings of the processor itself.

The content acquisition section 101 acquires content represented by a still image, a video image, or a text by way of the network 110. The content include program information being received from the broadcast station 112, information about a program in the same time slot on a different channel, or the like. In addition, the content may also include setting information (e.g., time information) about the content display processing device. In order to speed up content acquisition processing, the content acquisition section 101 may also acquire content only when there are changes in the content. Moreover, the content acquisition section 101 may also acquire content in accordance with input operation performed by the user through use of an input device.

The video image acquisition section 102 acquires video image data distributed by the broadcast station 112. The video image data include data pertaining to still images making up a frame. In addition to acquiring video image data distributed by the broadcast station 112, the video image acquisition section 102 may also acquire a wired broadcast provided by a cable TV, or the like; a stream distributed by way of the network 110; and video image data by way of various recording mediums, such as a DVD, a BD, and an HDD (Hard Disc Drive) or from an imaging device, such as a camera.

The image processing section 103 extracts a frame from the video image data acquired by the video image acquisition section 102 and takes out still images making up one frame.

The image recognition section 104 detects a free area in a still image taken out by the image processing section 103. The term “free area” implies an area that includes an interior of a still image and at least a portion of an edge of the still image and from which a major display object of the still image is eliminated.

The image recognition section 104 first converts pixels of a still image into numerals by any one or combination of brightness, color saturation, and a color tone. The image recognition section 104 next smoothes the pixel value, to thus eliminate noise. The image recognition section 104 determines a difference of pixel value between adjacent pixels. The image recognition section 104 detects an area of pixels where a difference of pixel value is larger than a threshold value as an edge of a main display target in the still image.

The image recognition section 104 detects, of the area from which there is eliminated the main display target in the still image enclosed by the detected edge, at least an area including an outer edge of the still image as a “free area” used for positioning content. The reason for this is that the main display target in the still image, which is an important portion of a video image, is usually displayed in the vicinity of a center area of a still image rather than along an outer edge of the same.

The image recognition section 104 may also detect, as a “free area” for positioning content, an area that does not have any edge or has a few edge and where small changes arise in a main display target image.

The image recognition section 104 can also detect a free area used for positioning content, by means of any one or a combination of brightness, color saturation, and a color tone and without extracting an edge of the main display target in the still image.

For instance, when brightness is used, the image recognition section 104 detects, as a free area used for positioning content, an area including at least an outer edge of a still image of the area whose brightness is lower than a predetermined value. An area having low brightness level; namely, a dark area, will not include important information about a video image with high possibility.

When color saturation is used, the image recognition section 104 detects, as a free area used for placing content, an area including at least an outer edge of a still image of the area whose color saturation is lower than a predetermined level. The reason for this is that an area with a low color saturation level that looks less-bright and dark will not include important information about a video image with high possibility. Likewise, when a color tone is used, the image recognition section 104 determines an average color tone value of divided areas and groups the areas for each similar color of area.

The image recognition section 104 links adjacent areas for each similar color of area when a difference of color tone between adjacent areas is smaller than a threshold value. The image recognition section 104 detects, as a free area used for placing content, an area including at least an outer edge of a still image of the area unified according to a similar color.

The content layout section 105 determines the layout and size of content from the free area detected by the image recognition section 104.

The free area detected by the image recognition section 104 for placing content is an area that includes at least an outer edge of a still image and that is determined by exclusion of a main display target of the still image. In Embodiment 1, the still image assumes a rectangular shape. When the shape of the still image is rectangular, the outer edge of the still image includes at least one of four corners of the still image or at least one of points on four sides of the still image. Further, the outer edge of the still image may also be a strip-shaped area formed to a preset width from respective four sides of the still image.

The content layout section 105 divides a still image into an N×M matrix of rectangular areas (N and M are natural numbers). Of the divided rectangular areas, an aggregate of free areas detected by the image recognition section 104 is determined, to thus be taken as a candidate area used for placing content.

The content layout section 105 next selects a content display area from the respective candidates for content layout areas. It is determined whether or not the shape of scaled-up or scaled-down content can be arranged in each of the candidates for content layout areas while an aspect ratio of content is maintained, and an area where content is to be placed is selected.

When there are a plurality of candidate areas where content can be placed, the content layout section 105 selects an area having the largest area among the candidates as a content display area.

Moreover, when there are a plurality of contents, it may also be possible to classify the contents under groups in accordance with a content type, a content generation time, a content size, or semantic classification of contents and to categorize layout areas for each of the contents in the same group. The content layout section 105 generates, from the selected area, content display information showing content layout and size.

In the content display processing device 100 of Embodiment 1, the image processing section 103, the image recognition section 104, and the content layout section 105 are made up of a CPU, or the like. In addition to controlling functions performed by the image processing section 103, the image recognition section 104, and the content layout section 105, the CPU also controls the entirety of the content display processing device. The CPU has ROM, RAM, EEPROM (Electrically Erasable Programmable Read Only Memory) that is an electrically rewritable nonvolatile memory, flash ROM, or the like. Memory stores a variety of sets of data, such as a program, communication control data, and identification codes of terminals.

The display information storing section 107 is memory that stores content display information generated by the content layout section 105.

The display processing section 106 superimposes content on a video image in accordance with the content display information generated by the content layout section 105, thereby transferring the video image with the overlaid content to the display unit 113.

The display unit 113 displays a video image transferred from the display processing section 106. In Embodiment 1, the display unit 113 is an external device, and the present invention is not limited to the external device. The display unit 113 can also be provided in the content display processing device 100.

As mentioned above, when content is displayed, in a superimposed manner, on a video image whose display details frequently changes, the content display processing device of Embodiment 1 will not block an important portion of a video image even if a content layout is not previously determined. The content display processing device of Embodiment 1 can also perform processing for displaying content while the content is superimposed on a video image.

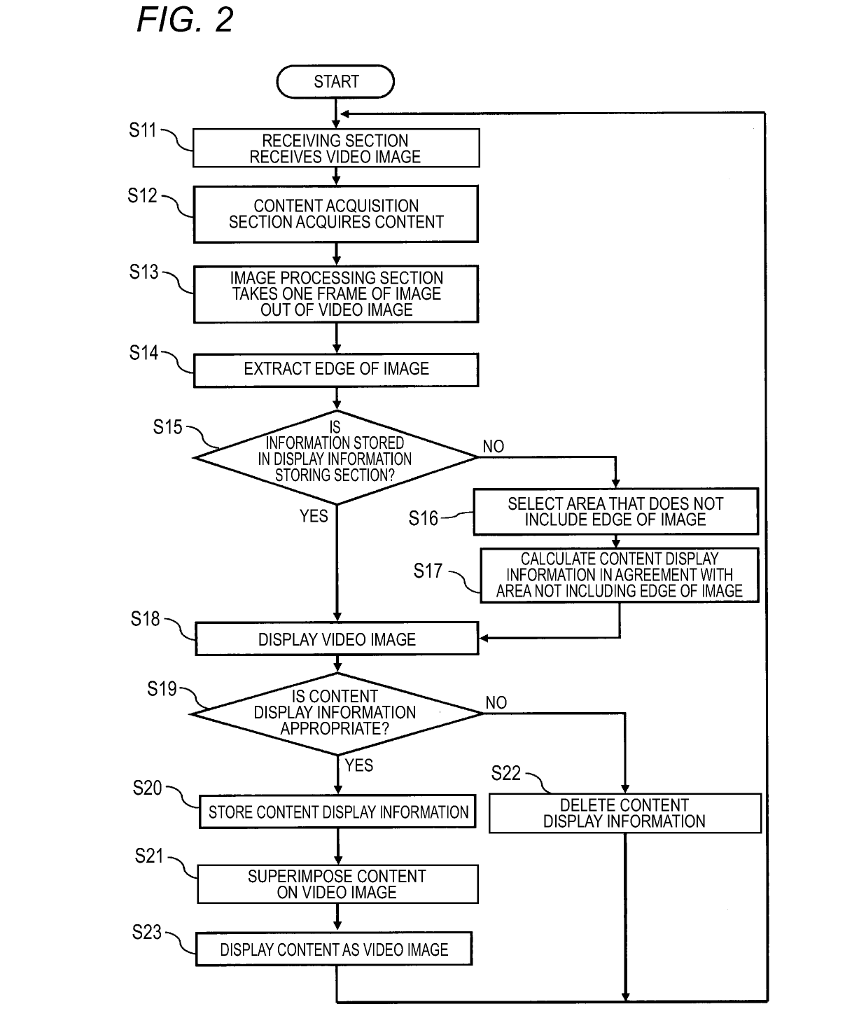

Operation of the content display processing device 100 configured as mentioned above is now described by reference to FIG. 2. FIG. 2 is a flowchart showing processing operation of the content display processing device 100 of Embodiment 1 of the present invention.

In step S11, the video image acquisition section 102 receives a signal transmitted from the broadcast station 112 and acquires a video image.

In step S12, the content acquisition section 101 acquires content from the content server 111 by way of the network 110.

In step S13, the image processing section 103 extracts a frame from the video image acquired by the video image acquisition section 102, takes out a plurality of still images, and stores the thus-extracted images.

In step S14, the image recognition section 104 extracts an edge of a main display target image in a still image (hereinafter called an “image edge”) from the plurality of still images stored in the image processing section 103.

In step S15, it is ascertained whether or not the content display information is recorded in the display information storing section 107.

When the content display information is not recorded, processing proceeds to step S16. When content display information is recorded, processing proceeds to step S18.

In step S16, the image recognition section 104 selects a free area from an area that does not include any image edge within the still image from which the main display target has been eliminated.

In step S17, the content layout section 105 recalculates content display information showing a content layout and a content size, in accordance with the free area selected in step S16. Although details are provided later, when the display information storing section 107 calculates the content display information, there are available two methods; namely, a method for calculating a content layout first and a method for calculating a content size first.

In step S18, the display processing section 106 displays a video image.

In step S19, the content layout section 105 ascertains whether or not recalculated content display information is appropriate. Here, what is appropriate means a case where content is positioned in a free area of a still image or where a content size is larger than a predetermined threshold value.

When the content display information is appropriate, processing proceeds to step S20.

In contrast, when the content display information is not appropriate, processing proceeds to step S22.

In step S20, the content display information is stored in the display information storing section 107.

In step S21, the display processing section 106 performs processing for displaying content on a video image in an superimposed manner, in accordance with the content display information. In step S23, the display unit 113 that is an external device displays a video image with superimposed content. Subsequently, processing returns to step S11.

In step S22, the content display information in the display information storing section 107 is deleted. Subsequently, processing returns to step S11.

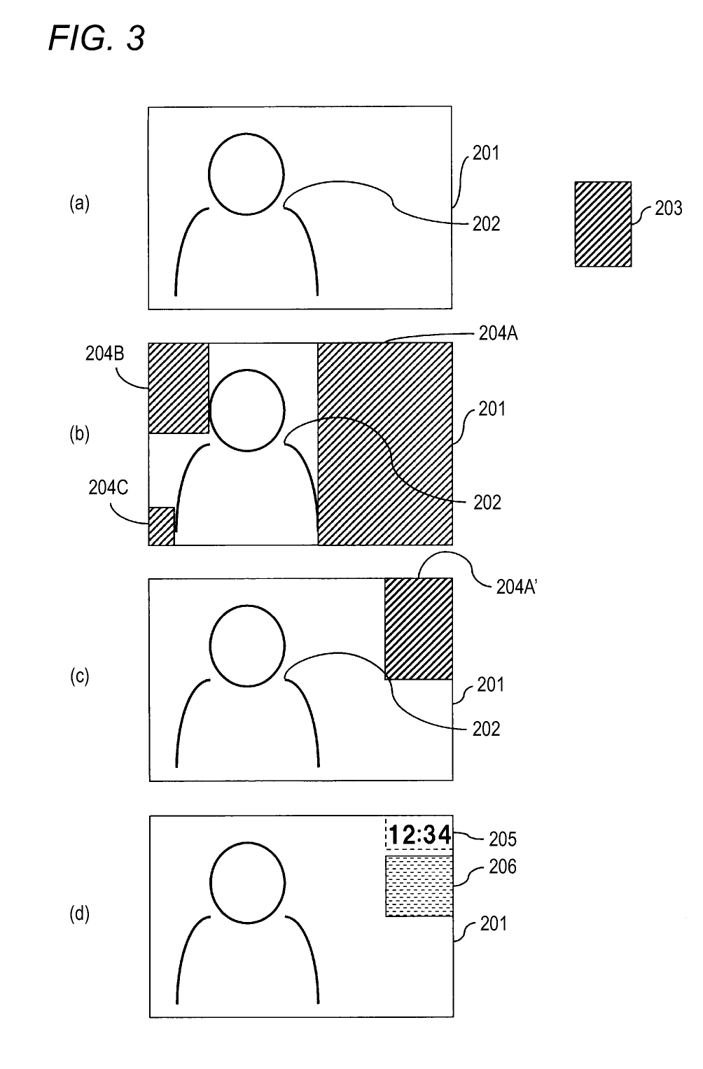

A content layout performed by the content display processing device 100 is now described by reference to FIGS. 3 through 6. In FIGS. 3 through 6, all of the still image, the candidate for a content layout area, and the content area assume rectangular shapes but may also assume circular shapes or other shapes.

FIG. 3 is a view for describing a content layout method for a content display processing device of Embodiment 1 of the present invention. FIG. 3(a) shows an example edge in an extracted image and example content to be displayed in a superimposed manner. FIG. 3(b) shows three candidate areas that enable positioning of the content shown in FIG. 3(a). FIG. 3(c) shows a content display area in an area selected from the three candidate areas shown in FIG. 3(b). FIG. 3(d) shows content displayed in the content display area shown in FIG. 3(c).

When contents 205 and 206 shown in FIG. 3(a) are displayed on a still image 201 including an edge 202, the content layout section 105 detects three candidate areas 204A, 204B, and 204C as shown in FIG. 3(b). A rectangular area 203 shows the size of an area where the contents 205 and 206 are displayed. These three candidate areas 204A, 204B, and 204C are identical with the rectangular area 203 in terms of an aspect ratio. Each of the candidate areas includes at least one of four corners of the still image 201 and does not overlay a main display target surrounded by the edge 202.

The content layout section 105 selects a candidate area 204a having the largest area from among the three candidate areas 204A, 204B, and 204C. Further, the content layout section 105 determines an area 204A′ shown in FIG. 3(c) within a selected candidate area 204A as a content display area in accordance with an upper limit value of a preset content display size. When the size of the candidate area is smaller than the original content size, the content layout section 105 may scale-down the content within a range where the scalded-down size does not become smaller than a lower limit value of the preset content display size. When the size of the selected candidate area is smaller than a preset threshold value, the content is not displayed in the selected area.

When determined the layout and size of the content display area 204A′, the content layout section 105 stores the layout and size as content display information in the display information storing section 107. In accordance with the content display information stored in the display information storing section 107, the display processing section 106 performs processing for displaying the contents 205 and 206 while the contents are superimposed on a video image as shown in FIG. 3(d).

In the example shown in FIG. 3(d), the two contents 205 and 206 are displayed in the content display area 204A′. Thus, when there are a plurality of contents to be displayed, foregoing processing may also be performed on a content-by-content basis, and there may also be performed processing for displaying content in each of different content display areas.

There is now described a method for re-calculating content display information when the edge of the main display target image overlays the content as a result of a change having occurred in a video image after positioning of the content.

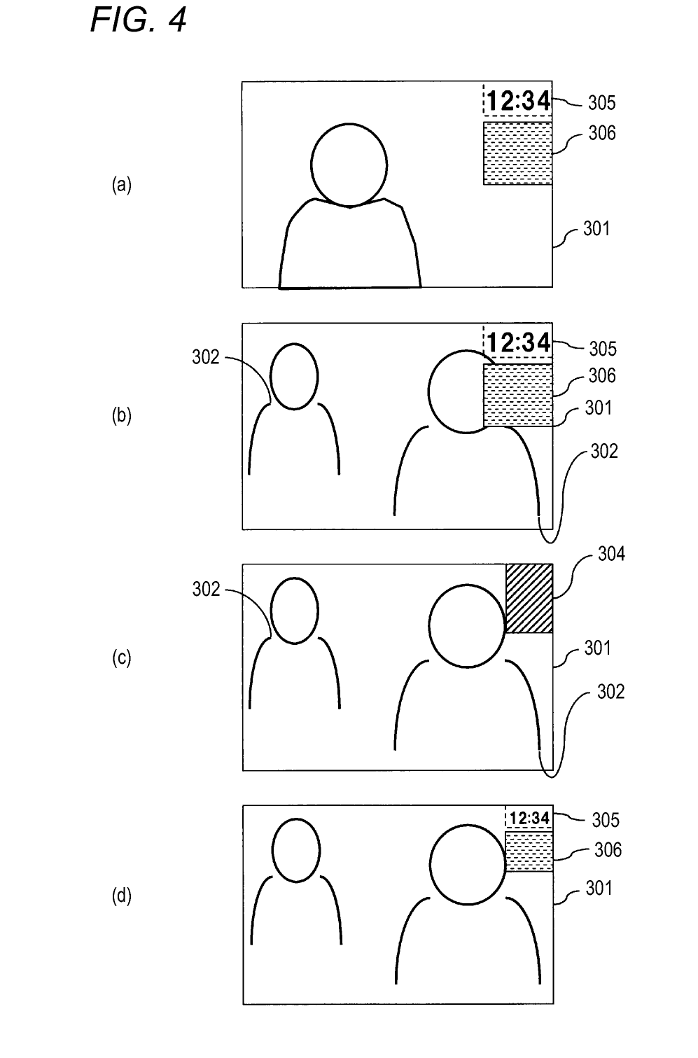

A method for re-calculating content display information while priority is given to the current content layout is first described by reference to FIG. 4. FIG. 4 is a view for describing a method for changing a content size in the content display processing device of Embodiment 1 of the present invention. FIG. 4(a) is a view showing a still image 301 achieved before re-calculation. FIG. 4(b) is a view showing the still image 301 whose edge overlays content. FIG. 4(c) is a view showing the still image 301 in which content is stepwise scaled-down. FIG. 4(d) is a view showing that a content image is superimposed on the still image 301 after re-calculation.

FIG. 4(a) shows the still image 301 achieved before re-calculation. Two contents 305 and 306 are displayed while the upper right corner of the still image 301 is taken as a reference. When the still image 301 has changed from FIG. 4(a) to FIG. 4(b), the content layout section 105 re-calculates the content display information while giving priority to the content layout. First, since the contents 305 and 306 overlay an edge 302 of the image, the content layout section 105 ascertains whether or not a content-displayed area can stepwise be scaled-down to a preset threshold value.

As shown in FIG. 4(c), when content can be scaled-down, the content layout section 105 stepwise scales down a content display candidate area 304 until an overlap between the contents 305, 306 and the edge 302 of the image becomes extinct. In accordance with the size of the stepwise-scaled-down candidate area 304, the content layout section 105 re-calculates content display information.

As shown in FIG. 4(d), in accordance with the content display information re-calculated by the content layout section 105, the display processing section 106 performs processing for displaying the contents 305, 306 in the content display candidate area 304 in a superimposed manner. The display processing section 106 superimposes the contents 305 and 306 on the video image. The display processing section 106 transfers the video image with the overlaid contents 305 and 306 to the display unit 113 that is an external device. The display unit 113 displays the video image with the overlaid contents 305 and 306 transferred from the display processing section 106.

Although FIG. 4 shows that the upper right corner of the still image 301 is used as a reference point for scale-down processing, at least one of four corners of content or a center of content can also be used as a reference to scale-down processing. Moreover, when no overlap exists between the contents 305, 306 and the edge 302 of the image, it is ascertained whether or not the contents can stepwise be scaled up to a preset threshold value, and the contents 305, 306 can be scaled up to a size to which contents can be scaled up. At least one of four corners of content or a center of content can be used as a reference for scale-up processing as in the case with scale-down processing.

As mentioned above, there is a case where the edge of a main display target image in a still image overlays the contents even when the content layout section 105 has re-calculated the content display information while giving priority to the current content layout. In this case, it is considered that the content layout section 105 will change (1) a content display method or (2) a content layout in order to re-calculate the content display information.

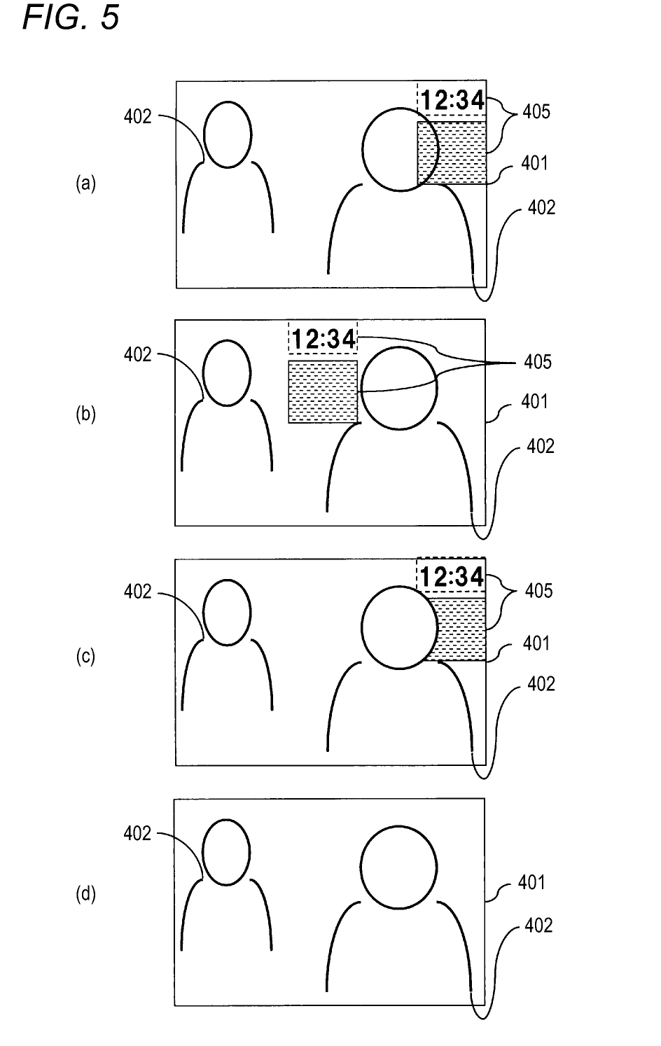

Explanations are hereunder provided to case (1) where a content display method is changed, by reference to FIG. 5. FIG. 5 is a view showing an example content display of the content display processing device of Embodiment 1 of the present invention. In particular, explanations are provided to a case where an image edge overlays contents even when the contents are stepwise scaled-down to a preset threshold value.

In an example display (1) shown in FIG. 5(a), the content layout section 105 changes the degree of transparency of the content 405 by means of an extent to which the edge overlaps the content 405 within the still image 401. In this case, the content layout section 105 adds information showing the degree of transparency of the content 405 to the content display information showing the layout and size of the content 405. As the amount of the edge overlapping the content 405 increases, the content layout section 105 increases the degree of transparency of the content 405, thereby making the content 405 more transparent.

When the edge 402 of the image overlaps the content 405 to an extent that is equal to or greater than the threshold value, the content layout section 105 discards content display information. Alternatively, the content layout section 105 may also divide the content 405 along the edge 402 of the image and place the content 405 in the largest area.

In an example display (2) shown in FIG. 5(b), the content layout section 105 moves the content 405 within the still image 401 in a direction where the edge 402 of the image does not exist. When the content 405 does not overlap the edge 402 of the image within an extent that does not exceed the upper limit value of the preset amount of movement, the content layout section 105 re-calculates content display information. In accordance with the re-calculated content display information, the display processing section 106 performs processing for displaying the content 405 while the content is superimposed on a video image. When the overlap exceeds the upper limit value of the preset amount of movement, the content layout section 105 discards content display information about the still image 401 being processed.

In an example display (3) shown in FIG. 5(c), when the size of the content 405 is larger than a preset threshold value, the content layout section 105 places the content 405 in the still image 401 while an overlap of the content with the edge 402 of the image is clipped, and the content display information is re-calculated. In accordance with the re-calculated content display information, the display processing section 106 performs processing for displaying the content 405 while the content is superimposed on a video image. When a content 405′ becomes smaller than the preset threshold value, the content layout section 105 discards the content display information as in the case of an example display (4) shown in FIG. 5(d).

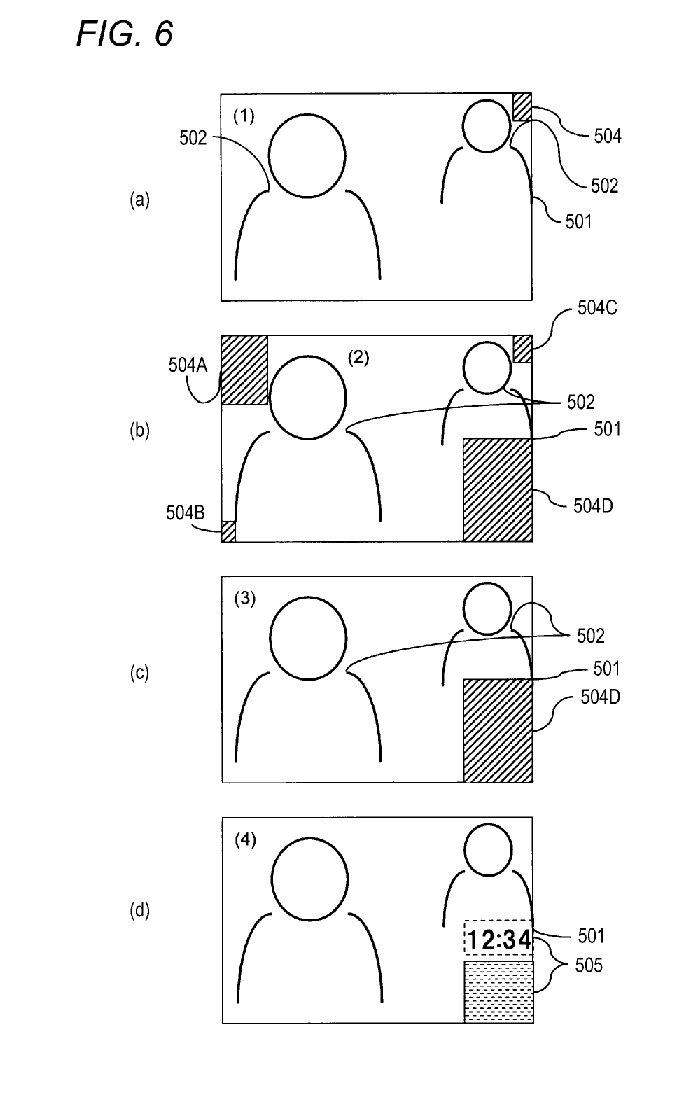

A case where a change is made to a content layout is now described by reference to FIGS. 6(a) to 6(d). FIG. 6 shows drawings representing types of content display methods for use in the content display processing device of Embodiment 1 of the present invention.

FIG. 6 provides a description about a case where, when a content 504 is scaled-down to such an extent that the content does not overlap an edge 502 of an image, the size of the content 504 becomes smaller than the preset threshold value. In FIG. 6, a description is provided by means of taking four corners of the still image 501 as a reference for a case where a change is made to the layout of the content. However, the reference is not limited to the four corners. It is also possible to taken arbitrary points on respective four sides of the still image 501 as references.

In an example display (5) shown in FIG. 6(a), the size of the content 504 in the still image 501 is smaller than a preset threshold value. Accordingly, as in the case of an example display (6) shown in FIG. 6(b), the content layout section 105 generates candidate areas 504A, 504B, 504C, and 504D that have the same aspect ratio as that of the content 504 and that are intended for displaying the content 504, by means of taking respective four corners of the still image 501 as reference. The sizes of the respective candidate areas are set so as not to overlap the edge 502 of the image in the still image.

As in the case of an example display (7) shown in FIG. 6(c), the content layout section 105 selects, from the candidate areas 504A, 504B, 504C, and 504D for displaying the content 504, the candidate area 504D having the largest area as an area for actually displaying content. In accordance with the size and position of the candidate area 504D, the content layout section 105 re-calculates the content display information and determines content display information.

As in the case of an example display (8) shown in FIG. 6(d), the display processing section 106 performs processing for displaying a content 505 while the content is superimposed on a video image, in accordance with the re-calculated content display information. The display unit 113 displays a video image transferred from the display processing section 106.

As mentioned previously, the content layout section 105 re-calculates content display information while giving priority to the current content layout. Even when the image edge overlays the content, the content layout section 105 re-calculates the content display information by changing (1) the content display method or (2) the content layout. In accordance with the re-calculated content display information, the display processing section 106 performs processing for displaying content while the content is superimposed on a video image. Therefore, even when an area capable of displaying content is changed in accordance with a change in video image, the content display processing device of Embodiment 1 can perform processing for displaying content on a video image without blocking an important portion of the video image.

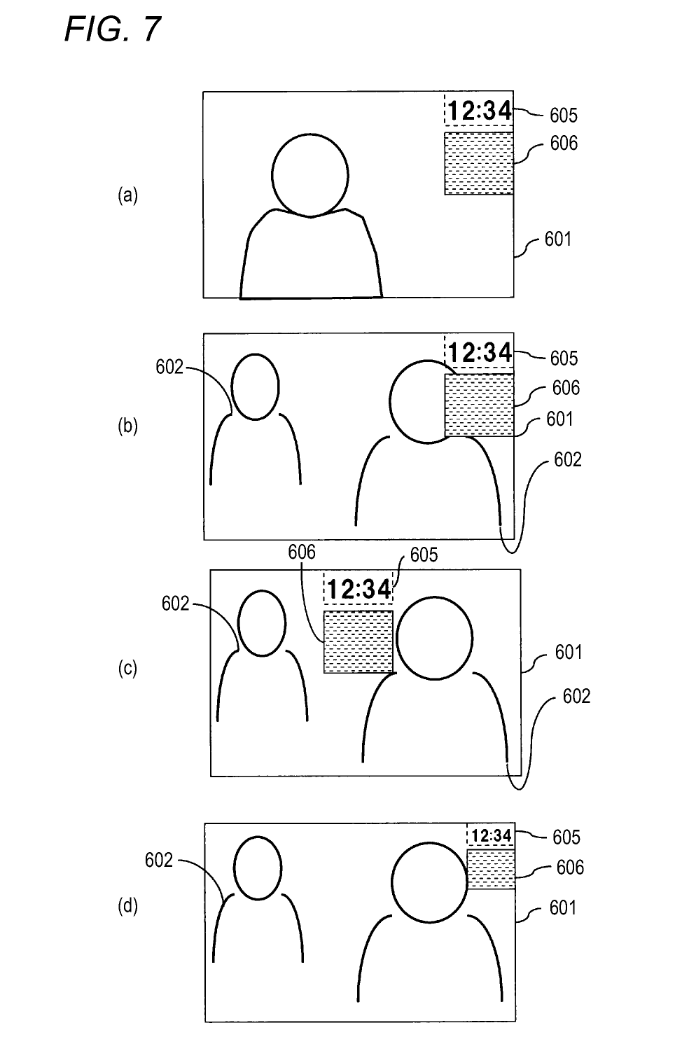

By reference to FIG. 7, a description is subsequently provided to a case where content display information is re-calculated by giving priority to the current content size. FIG. 7 is a view for describing a method for re-calculating content display information in the content display processing device of Embodiment 1 of the present invention. FIG. 7(a) is a view showing a still image 601 achieved before re-calculation. FIG. 7(b) is a view showing the still image 601 in which content and an image edge overlap each other. FIG. 7(c) is a view showing the still image 601 in which the content and the image edge do not overlap each other. FIG. 7(d) is a view in which a content image is superimposed on the still image 601 after re-calculation.

FIG. 7(a) shows the still image 601 achieved before re-calculation. Two contents 605 and 606 are displayed while an upper right corner of four corners of the still image 601 is taken as a reference. In FIG. 7, the upper right corner of the still image 601 is used as a reference point for scale-down processing.

There is now described method by means of which the content layout section 105 re-calculates content display information while giving priority to a content size when the still image 601 changes from FIG. 7(a) to FIG. 7(b) as a result of occurrence of a change in video image. When there is no change in the still image 701, the content layout section 105 re-calculates the content display information from the current content display information.

When an edge 602 of an image overlaps contents 605 and 606 as shown in FIG. 7(b), the content layout section 105 moves the contents 605 and 606 so as to prevent the edge 602 of the image overlapping the contents and re-calculates the content display information, as shown in FIG. 7(c). When the amount of movement of the contents surpasses the preset upper limit value, the content layout section 105 stepwise scales down the contents 605 and 606 without moving the same while maintaining an aspect ratio of the contents.

The content layout section 105 ascertains whether or not the contents 605 and 606 can stepwise be scaled down to a preset threshold value. As shown in FIG. 7(d), the content layout section 105 scales down the contents 605 and 606 in such a way that the edge 602 of the image does not overlap the contents 605 and 606, thereby re-calculating the content display information. In accordance with the re-calculated content display information, the display processing section 106 performs processing for displaying the contents 605 and 606 on a video image in a superimposed manner.

Even when a change arises in a content-displayable area according to a change in a video image, re-calculating operation enables performance of processing for displaying content while the content is superimposed on a video image, without blocking a main display target of the video image. In FIG. 7, an upper right corner of the still image 601 is used as a reference point for scale-down processing. However, any one of four corners of either the content 605 or 606 or the center of either the content 605 or 606 may also be used as a reference for scale-down processing.

As mentioned above, even when content display information is re-calculated while priority is given to the current content size, an image edge sometimes overlaps content. In this case, a method, such as that provided below, is available in order to calculate the content display method.

For instance, in a case where an image edge is included even after content has been scaled down to a preset threshold value, the content layout section 105 changes a content layout. When an image edge overlaps content even after a change has been made to the content layout, the content layout section 105 discards the current content display information, and the display processing section 106 performs processing such that content is not displayed in a video image.

Moreover, for instance, the content layout section 105 may also display translucent content on a still image by changing the degree of transparency of content in accordance with an area of an overlap between content and an edge. When the image edge overlaps content to such an extent that is equal to or greater than a threshold value, the content layout section 105 discards content display information. Alternatively, the content layout section 105 may also divide the content display area along the edge and take the largest area as a display area.

In Embodiment 1, when scaling up or down content and when moving content within a predetermined range, the content layout section 105 may also interpolate the content display information stored in the display information storing section 107 and content display information re-calculated by the content layout section 105.

In this case, the content layout section 105 prepares content display information from complementary data. The display processing section 106 performs processing for consecutively displaying content by means of content display information based on interpolated data. When the display unit 113 is displaying an image in accordance with the content display information based on interpolated data, an overlap may exist between the image edge and the content. However, there is yielded an advantage of the user becoming easier to pursue content.

As has been described in detail above, the content display processing device of Embodiment 1 detects, as a free area for displaying content, an area including an outer edge of a still image in the area from which the main display target in the still image making up a video image is eliminated. The content display processing device of Embodiment 1 performs processing for: determining content display information made up of a content layout and a content size in accordance with the detected free area and displaying content on a video image in a superimposed manner in accordance with the content display information. As a result, even when a change has arisen in a content-displayable area according to a change in video image, it is possible to perform processing for displaying content on a video image without blocking an important portion of the video image.

Although Embodiment 1 has described the present invention by use of an example application of the content display processing device to a TV receiver capable of receiving a digital broadcast radio wave, the present invention is not limited to the example. The content display processing device of the present invention can also be applied to a portable game machine as well as to an optical disc player, a hard disc recorder, a portable phone, a PHS (Personal Handy-Phone System), a PDA (Personal Digital Assistants), a personal computer, and imaging devices, such as a digital still camera and a digital movie camera.

The respective function blocks used for describing the embodiment are implemented by an LSI that is typically integrated circuit. The function blocks can also be packed individually into a single chip or embodied as a single chip so as to include some or all of the function blocks. Although the chip is embodied as an LSI, the chip is also referred to as an IC, a system LSI, a super LSI, or an ultra LSI according to the degree of integration.

The technique for implementing an integrated circuit is not limited to the LSI. The integrated circuit can also be implemented by a custom-designed circuit or a general-purpose processor. An FPGA (Field Programmable Gate Array) that can be programmed after manufacture of an LSI or a reconfigurable processor that enables reconfiguration of connections and settings of circuit cells in an LSI may also be utilized.

If a technique of integrating a circuit that is substituted by an LSI emerges by means of another technique resultant from advancement or derivation of the semiconductor technique, the functional blocks may naturally be integrated by use of the technique. Application of biological technique, and the like, is feasible.

Although the present invention has been described in detail and by reference to the specific embodiment, it is manifest to those skilled in the art that various alterations and modifications be added to the present invention without departing the spirit and scope of the present invention.

The present patent application is based on Japanese Patent Application (Japanese Patent application No. 2008-224590) filed on Sep. 2, 2008, the entire subject matter of which is incorporated herein by reference.

### INDUSTRIAL APPLICABILITY

The present invention can be applied to a content display processing device and a content display processing method that make it possible to display content while the content is superimposed on a video image, without blocking an important portion of the video image.

### DESCRIPTIONS OF THE REFERENCE NUMERALS AND SYMBOLS

100 CONTENT DISPLAY PROCESSING DEVICE
101 CONTENT ACQUISITION SECTION
102 VIDEO IMAGE ACQUISITION SECTION
103 IMAGE PROCESSING SECTION
104 IMAGE RECOGNITION SECTION
105 CONTENT LAYOUT SECTION
106 DISPLAY PROCESSING SECTION
110 NETWORK
111 CONTENT SERVER
112 BROADCAST STATION
113 DISPLAY UNIT
201, 301, 401, 501, 601 STILL IMAGE
202, 302, 402, 502, 602 EDGE OF IMAGE
203 RECTANGULAR AREA
204A, 204B, 204C, 304, 504A, 504B, 504C, 504D CANDIDATE AREA
204A′ CONTENT DISPLAY AREA
205, 206, 305, 306, 405, 504, 505, 605, 606 CONTENT

1. A content display processing device comprising:
a video image acquisition section that acquires a video image made up of a plurality of still images;
a content acquisition section that acquires content to be displayed on the video image so that the content is superimposed on the video image;
an image processing section that extracts the still image from the video image;
an image recognition section that detects, from the still image extracted by the image processing section, an area which includes at least a portion of an outer edge of the still image and a portion except a main display object in the still image;
a content layout section that determines content display information indicating a layout and a size of the content according to the area detected by the image recognition section; and
a display processing section that performs processing so as to display the content while the content is superimposed on the video image, in accordance with the content display information determined by the content layout section.

2. The content display processing device according to claim 1, further comprising:
a display information storing section that holds the content display information,
wherein the content layout section redetermines the content display information in accordance with a change in a position or the size of the main display object while maintaining either the layout or the size of the content indicated by the content display information stored in the display information storing section.

3. The content display processing device according to claim 1, wherein the image processing section performs image processing of the still image to extract an edge of the main display target.

4. The content display processing device according to claim 1, further comprising:
a display information storing section that holds the content display information,
wherein the content display information includes information about a degree of transparency of the content; and
wherein the content layout section determines the degree of transparency of the content in accordance with a change in a position or the size of the main display object while maintaining the layout and the size of content indicated by the content display information stored in the display information storing section.

5. The content display processing device according to claim 1, wherein the display processing section performs processing for displaying a portion of the content, which does not overlap the main display object, so as to be superimposed on the video image when the main display object overlaps the content as a result of the content being superimposed on the video image in accordance with the content display information.

6. The content display processing device according to claim 2, wherein the content layout section determines third content display information which interpolates first content display information and second content display information based on a difference between the first content display information stored in the display information storing section and the second content display information determined by the content layout section; and
wherein the content layout section determines the third content information as the content display information.

7. The content display processing device according to claim 1, wherein a shape of the still image is rectangular; and
wherein the outer edge of the still image includes at least one of four corners of the still image or at least one point on four sides of the still image.

8. A content display processing method, comprising:
acquiring a video image made up of a plurality of still images;
acquiring a content to be displayed on the video image so that the content is superimposed on the video image;
extracting the still image from the video image;
detecting, from the extracted still image, an area which includes at least a portion of an outer edge of the still image and a portion except from which a main display object in the still image;
determining content display information indicating a layout and a size of the content according to the detected area; and
displaying the content on the video image while the content is superimposed on the video image, in accordance with the determined content display information.
